(19) United States
(12) Patent Application Publication
(10) Pub. No.: US 2014/0251496 A1
(43) Pub. Date: Sep. 11, 2014

(54) Disposable Water Bottle Fittable To An Infant Feeding Nipple

(71) Applicant: Debra Kay Ashworth, Mission Viejo, CA (US)

(72) Inventor: Debra Kay Ashworth, Mission Viejo, CA (US)

(21) Appl. No.: 13/792,037

(22) Filed: Mar. 9, 2013

(51) Int. Cl. A61J 9/00

(52) U.S. Cl. CPC A61J 9/00
USPC 141/11; 215/11.6; 141/1

(57) ABSTRACT

Disclosed herein is a disposable infant feeding bottle including a disposable water bottle comprising a neck adapted to attach to an infant feeding nipple. For example, a disposable infant feeding bottle can include a disposable bottle having a neck; water, contained within the bottle, in an amount sufficient to be mixed with infant formula to feed an infant, and in an amount that is less than the volume of the bottle so that infant formula mix can be added to the bottle to mix with the water without overflow of the water or the infant formula mix, such as about 2 to about 16 ounces of water. The infant feeding bottle may further include a coupling component configured to allow an infant feeding nipple to be removably attached to the bottle, wherein the coupling component forms a liquid-tight seal when the nipple is attached to the bottle; a disposable cap; and a tamper resistant component.

### SUMMARY

Disclosed herein is a disposable infant feeding bottle comprising a disposable water bottle comprising a neck adapted to attach to an infant feeding nipple.

Some embodiments include a disposable infant feeding bottle comprising: a disposable bottle having a neck; water, contained within the bottle, in an amount sufficient to be mixed with infant formula to feed an infant, and in an amount that is less than the volume of the bottle so that infant formula mix can be added to the bottle to mix with the water without overflow of the water or the infant formula mix; a coupling component configured to allow an infant feeding nipple to be removably attached to the bottle, wherein the coupling component forms a liquid-tight seal when the nipple is attached to the bottle; a disposable cap; and a tamper resistant component.

Some embodiments include a disposable infant feeding kit comprising a disposable infant feeding bottle described herein, and infant formula in a separate container, wherein infant formula is present in an amount that is correlated with the amount of water, so that mixing all of the water in the bottle with all of the formula in the kit provides an infant formula of an appropriate concentration for feeding an infant.

Some embodiments include a method of preparing infant formula comprising adding infant formula to the water in the disposable infant feeding bottle described herein. The bottle may be shaken after adding infant formula to the water in the disposable infant feeding bottle to provide a formula.

### BRIEF DESCRIPTION OF DRAWINGS

FIG. 1 illustrates an embodiment of an infant feeding system.

FIG. 2 illustrates an embodiment of an infant feeding system.

### DETAILED DESCRIPTION

A disposable water bottle having a neck configured so that an infant feeding nipple may be attached may allow formula to be added to the water bottle and mixed with the water in the bottle. Thus, the infant may fed a prepared formula directly from the water bottle through an attached nipple. This may help to avoid, for example, having to mix water from a reusable infant bottle with dry formula mix in order to feed an infant. One advantage of this approach may be that, when traveling, a parent may pack a bottle of water only, instead of having to pack both a bottle of water and an empty formula bottle.

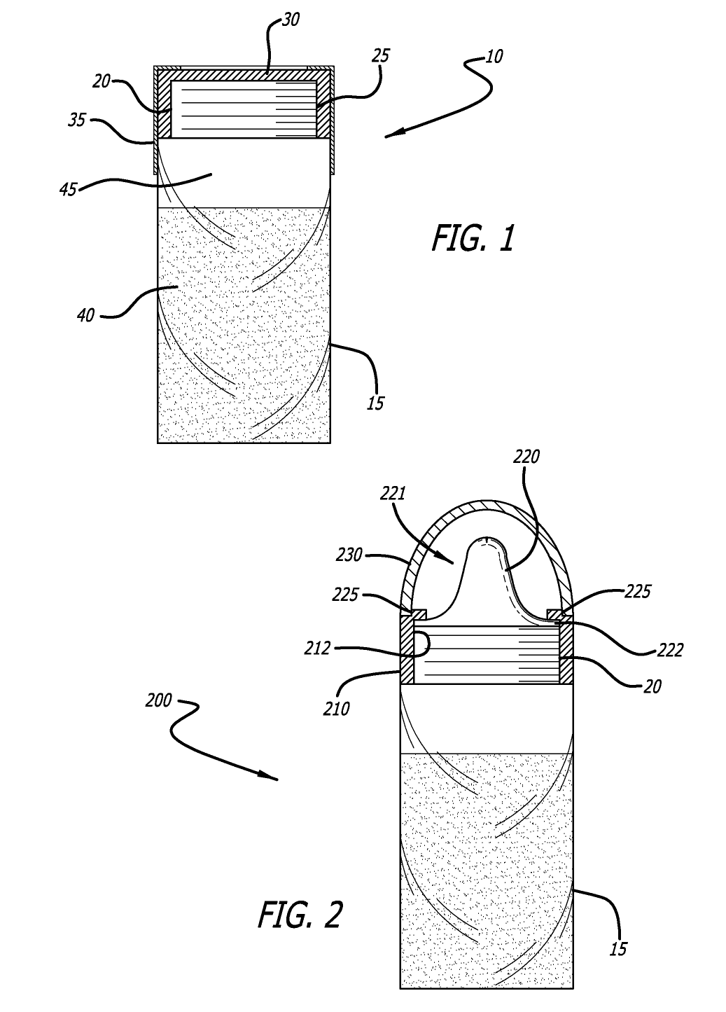

FIG. 1 illustrates some embodiments of such an infant feeding system 10. A bottle 15 may have neck 20 with coupling component 25 that allows cap 30 to be removably attached to neck 20. Tamper resistant component 35 is coupled to cap 30 so that it is evident to a potential user if cap 30 has been removed or bottle 15 has been opened. Bottle 15 may contain water 40, which may have a volume that is less than that of bottle 15, so that a space 45 is included to allow dry infant formula mix to be added to bottle 15 for mixing with water 40 to prepare an infant formula that is ready to feed to an infant.

A bottle, e.g. bottle 15, may be any disposable bottle that can be coupled to an infant nipple so that an infant may be directly fed the contents of the bottle. A bottle may be composed of any material that is suitable for a disposable bottle such as a disposable or a recyclable polymer, such as polyethylene, polypropylene, polyethylene glycol, polyethylene terephthalate or another terephthalate polyester, polyvinyl chloride, an acrylate such as poly(methyl methacrylate), poly(methyl acrylate), an acrylamide, polyvinyl acetate, polytetrafluoroethylene, a polyurethane, polystyrene, etc., or a glass. The thickness of the walls of a bottle may be suitable for disposal or recycling, such as less than about 2 mm, less than about 1 mm, about 0.01 mm to about 1 mm, about 0.01 mm to about 0.5 mm, about 0.1 mm to about 5 mm, about 0.01 mm to about 0.1 mm, about 0.01 mm to about 0.4 mm, about 0.01 mm to about 0.3 mm about, 0.01 mm to about 0.2 mm about 0.01 mm to about 0.1 mm, about 0.1 mm to about 0.2 mm, about 0.2 mm to about 0.3 mm, about 0.3 mm to about 0.4 mm, about 0.4 mm to about 0.5 mm, or any thickness in a range bounded by, or between, any of these values. A bottle may be of any volume that is suitable for feeding formula for an infant. In some embodiments, a bottle has a volume of about 1 fluid ounce to about 20 fluid ounces, about 2 fluid ounces to about 16 fluid ounces, about 4 fluid ounces to about 12 fluid ounces, about 4 fluid ounces to about 10 fluid ounces, about 4 fluid ounces to about 8 fluid ounces, or about 4 fluid ounces to about 6 fluid ounces.

A neck on a bottle, e.g. neck 20, may be any type of neck that is suitable for removably attaching an infant feeding nipple to a bottle to which a neck is attached. A neck may be any diameter that allows an infant feeding nipple to be removably attached, such as about 2 cm to about 8 cm, about 2 cm to about 3 cm, about 3 cm to about 4 cm, about 4 cm to about 5 cm, or about 5 cm to about 6 cm. Alternatively, an infant feeding nipple may be sized to fit to standard disposable water bottle sizes.

Some embodiments include an infant feeding nipple that is sized to fit to standard disposable water bottle neck sizes, so that the cap of a commercial bottle of water can be removed, and the infant feeding nipple can be added.

A neck may include a coupling component, e.g. coupling component 25, that is configured to allow a cap or an infant feeding nipple to be removably attached to the neck. When a neck is attached to a cap, the coupling component may form a liquid-tight seal between the bottle and the cap so that liquid from the bottle does not leak from the assembly of neck, coupling component, and cap. When a neck is attached to a nipple, the coupling component may form a liquid-tight seal between the bottle and the nipple so that liquid from the bottle may be fed to an infant via the nipple without liquid leaking from the assembly of neck, coupling component, and nipple. For example, a coupling component may be 1) a threading on the exterior of the neck that can couple to a threading on the interior of a cap, and 2) a rim on the top of the neck that can meet a cap or an infant feeding nipple to form a liquid-tight seal. Other types of coupling components, such as a flange and clamp type system, may be used.

A cap, e.g. cap 30, may be attached to the neck of a bottle via the coupling component. Any kind of cap may be used, provided that it is capable of keeping liquid contents of a bottle to which the cap is attached from leaking from an assembly of cap, neck, and coupling component. The cap may be composed of recyclable or disposable material such as a metal, e.g. aluminum, tin, or an alloy or mixture thereof, or a polymeric material such as polyethylene, polypropylene, polyethylene glycol, polyethylene terephthalate or another terephthalate polyester, a polycarbonate, polyvinyl chloride, an acrylate such as poly(methyl methacrylate), poly(methyl acrylate), an acrylamide, polyvinyl acetate, polytetrafluoroethylene, a polyurethane, polystyrene, etc.

A cap may be a distinct component from an infant feeding nipple, such cap 30 depicted in FIG. 1. If the cap is a distinct component from an infant feeding nipple, the cap may be removed, formula may be prepared by mixing water 40 in bottle 15, and dry infant formula mix, and an infant feeding nipple may be removably attached to bottle 15 before mixing, during mixing, or after mixing, so that an infant may be fed liquid formula from bottle 15 through the infant feeding nipple. An infant feeding nipple may be included in an infant feeding system 10, or may be separately obtained and used In some embodiments, an infant feeding nipple may be a reusable infant feeding nipple. In some embodiments, an infant feeding nipple may be a disposable infant feeding nipple.

Alternatively, a cap may comprise an infant feeding nipple. FIG. 2 depicts an embodiment of infant system 200 having cap 210 that comprises an infant feeding nipple. Infant feeding system 200 may be similar to infant feeding system 10 depicted in FIG. 1, except that cap 210 comprises infant feeding nipple 220. Infant feeding nipple 220 may comprise a feeding component 221 through which the formula is fed to the infant and a sealing component 222 that meets neck 20 and interior wall 212 of cap 210 to form a seal. Cap 210 is removably attached to neck 20 and cover 230. Cover 230 can fit, attach, or lock to an outer feature 225 of cap 210 so as to protect the infant feeding nipple 220 from exposure to contamination or to avoid loss of liquid contents of bottle 15.

A tamper resistant component, e.g. tamper resistant component 35, may be coupled to a cap, e.g. cap 30 or cap 210, so that it is readily apparent that a cap has been removed from the bottle when or that the bottle has been opened after the tamper resistant component was coupled to the cap. Some tamper resistant components comprise a perforated line that is broken or visibly damaged when the bottle is opened. For example, if a consumer purchases a bottle of water having a tamper resistant component, the consumer can readily tell if someone has already opened the bottle after the tamper resistant component was coupled to the bottle and cap. A tamper resistant component may be a ring attached to the neck and the cap. The ring may be attached to the cap by a breakable perforated line that is partially or completely broken when the cap is removed from the neck. A tamper resistant component can also be a wrap comprising a plastic or other material that surrounds part or all of both the bottle and cap, including part or all of the neck and the cap. The wrap is removed, broken, or damaged when the bottle is opened or tampered with, so that a purchaser can tell if the bottle has been opened or tampered with.

Bottle 15 may contain water 40, which may have a volume that is less than that of bottle 15, so that a space 45 is included to allow dry infant formula mix to be added to bottle 15 for mixing with water 40 to prepare an infant formula that is ready to feed to an infant. In some embodiments, water may be about 50% to about 95%, about 50% to about 60%, about 60% to about 70%, about 70% to about 80%, about 80% to about 95%, about 60% to about 90%, about 70% to about 85%, or about 70% to about 85% of the volume of a bottle in which it resides. In some embodiments, a bottle contains about 1 ounce to about 16 fluid ounces, about 1.5 fluid ounces to about 7 fluid ounces, about 1.5 fluid ounces to about 3.5 fluid ounces, about 2 fluid ounces to about 14 fluid ounces, about 3 fluid ounces to about 10 fluid ounces, about 3 fluid ounces to about 8 fluid ounces, about 3 fluid ounces to about 6 fluid ounces, or about 3 fluid ounces to about 5 fluid ounces of water.

In some embodiments, the bottle has volume that is about 2 fluid ounces to about 8 fluid ounces, a wall that has a thickness of about 0.1 mm to about 1 mm, a neck that has diameter of about 3 cm to about 5 cm, and the bottle contains about 1.5 fluid ounces to about 7 fluid ounces of water.

In some embodiments, the bottle has volume that is about 2 fluid ounces to about 4 fluid ounces, a wall that has a thickness of about 0.1 mm to about 1 mm, a neck that has diameter of about 3 cm to about 5 cm, and the bottle contains about 1.5 fluid ounces to about 3.5 fluid ounces of water.

In some embodiments, the bottle has volume that is about 2 fluid ounces to about 8 fluid ounces, a wall that has a thickness of about 0.1 mm to about 1 mm, a neck that has diameter of about 3 cm to about 5 cm, the bottle contains about 1.5 fluid ounces to about 7 fluid ounces of water, and the water is about 70% to about 90% of the volume of the bottle.

In some embodiments, the bottle has volume that is about 2 fluid ounces to about 4 fluid ounces, a wall that has a thickness of about 0.1 mm to about 1 mm, a neck that has diameter of about 3 cm to about 5 cm, the bottle contains about 1.5 fluid ounces to about 3.5 fluid ounces of water, and the water is about 70% to about 90% of the volume of the bottle.

Some embodiments include a disposable infant feeding kit comprising a disposable infant feeding bottle described herein, and infant formula in a separate container. The separate container may be any suitable container, such as a pouch or an envelope. The kit contains the infant formula in an amount that is correlated with the amount of water in the bottle, so that mixing all of the water in the bottle with all of the formula in the kit provides an infant formula of an appropriate concentration for feeding an infant. Thus, a parent may mix all of the infant formula in the kit with all of the water in the bottle to obtain an infant formula of an appropriate concentration for feeding an infant.

What is claimed is:

1. A disposable infant feeding bottle comprising:
a disposable bottle having a neck;
water, contained within the bottle, in an amount sufficient to be mixed with infant formula to feed an infant, and in an amount that is less than the volume of the bottle so that infant formula mix can be added to the bottle to mix with the water without overflow of the water or the infant formula mix;
a coupling component configured to allow an infant feeding nipple to be removably attached to the bottle, wherein the coupling component forms a liquid-tight seal when the nipple is attached to the bottle;
a disposable cap; and
a tamper resistant component.

2. The disposable infant feeding bottle of claim 1, wherein the disposable cap further comprises a nipple and a cover.

3. The disposable infant feeding bottle of claim 1, wherein the water has a volume that is about 60% to about 90% of the volume of the disposable bottle.

4. The disposable infant feeding bottle of claim 1, wherein the disposable bottle has a volume of about 4 fluid ounces to about 12 fluid ounces.

5. The disposable infant feeding bottle of claim 4, wherein the disposable bottle contains about 3 fluid ounces to about 10 fluid ounces of water.

6. The disposable infant feeding bottle of claim 1, wherein the disposable bottle has a volume of about 4 fluid ounces to about 8 fluid ounces.

7. The disposable infant feeding bottle of claim 6, wherein the disposable bottle contains about 3 fluid ounces to about 6 fluid ounces of water.

8. The disposable infant feeding bottle of claim 1, wherein the disposable bottle has a wall having a thickness of 0.01 mm to about 1 mm.

9. The disposable infant feeding bottle of claim 1, wherein the tamper resistant component comprises a perforated line.

10. The disposable infant feeding bottle of claim 1, wherein the tamper resistant component comprises a ring that is attached to the neck and the cap.

11. The disposable infant feeding bottle of claim 1, wherein the tamper resistant component comprises a plastic wrap.

12. A disposable infant feeding kit comprising a disposable infant feeding bottle according to claim 1, and infant formula in a separate container, wherein infant formula is present in an amount that is correlated with the amount of water, so that mixing all of the water in the bottle with all of the formula in the kit provides an infant formula of an appropriate concentration for feeding an infant.

13. A method of preparing infant formula comprising adding infant formula to the water in the disposable infant feeding bottle of claim 1.

14. The method of claim 13, wherein the bottle is shaken after adding infant formula to the water in the disposable infant feeding bottle.
